(19) United States
(12) Patent Application Publication
(10) Pub. No.: US 2007/0186986 A1
(43) Pub. Date: Aug. 16, 2007

(54) Primary/secondary loop purge valve

(76) Inventor: Michael E. Reck, Worcester, MA (US)

Correspondence Address: Brian L. Michaelis, Brown Rudnick Berlack Israels LLP, One Financial Center, Box IP, Boston, MA, 02111, US

(21) Appl. No.: 11/648,376

(22) Filed: Dec. 29, 2006

Related U.S. Application Data
(60) Provisional application No. 60/756,007, filed on Jan. 4, 2006.

(51) Int. Cl. F16K 11/20

(52) U.S. Cl. 137/597

(57) ABSTRACT

This invention comprises a purge valve comprising a valve body having a first primary loop port and a second primary loop port, the valve body defining a first secondary loop port and second secondary loop port, the valve body defining a flow channel and a valve portion, the valve portion in communication with the first, second, third, and forth port and a flow diversion device disposed within the valve portion, the flow diversion device configurable between a first and second position such that when the flow diversion device is in the first position the first primary loop port is in communication with the second primary loop port, the first secondary loop port and the second secondary loop port and when the flow diversion device is in a second position the first primary loop port is in communication with the first secondary loop port only and the second primary loop port is in communication with the second secondary loop port only.

### CROSS REFERENCE TO RELATED APPLICATIONS

This patent application claims the benefit of U.S. Provisional Patent Application Ser. No. 60/756,007, filed on Jan. 4, 2006, the contents of which being incorporated herein by reference in its entirety.

### FIELD OF INVENTION

The present invention relates to valves, particularly to a primary/secondary loop purge valve.

### BACKGROUND OF INVENTION

Primary/secondary (“P/S”) piping systems are used to isolate the pressure differential established by a pump from those established by other pumps in the same system. P/S piping allows any pump in the system to operate with virtually no tendency to induce flow, or even disturb flow, in other loops. P/S piping systems have become increasingly popular in many commercial and residential plumbing systems, such as hydronic heating and cooling systems. In such systems purge valves are essential to the operation and maintenance of the systems. Hydronic heating systems have gained popularity due to the comfortable average temperature they provide and due to minimal stratification. Hydronic systems use water, or water-based solutions, to move thermal energy from where it is produced to where it is needed. Thermal energy is absorbed by the water at a heat source, conveyed by the water through the distribution piping, and finally released into a heated space by a heat emitter. Because hydronic heating and cooling systems rely on the flow of water through the pipes, the presence of air bubbles or pockets within the piping can lead to inefficiency and malfunction of the system. Purge valves are used to empty the system of air upon installation and during maintenance to provide for a more efficient system. Previous systems utilized purge valves located on the secondary loop in order to remove air from the secondary loop. The use of such valves can lead to pressure differentials that can affect the operation of the remainder of the system.

### SUMMARY OF INVENTION

A P/S loop purge valve that allows for the elimination of air from a piping system with no discemable pressure decrease is disclosed. The valve allows for power purging off a secondary loop in the installation of hydronic systems. An embodiment of the present invention includes a valve body containing a flow channel extending through the body from a first primary loop port to a second primary loop port. The valve body also contains first and second secondary loop ports in communication with the flow channel. A flow diversion device is disposed in the valve body to control and alter the flow channel through the various ports of the valve body. The flow diversion device is disposed within the flow channel between the first and second secondary loop ports. The flow diversion device in a first position allows open flow through all ports of the valve. In a second position, the flow diversion device directs flow from the first primary loop port to the first secondary loop port and flow from the second secondary loop port to the second primary loop port.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is an axial view of an embodiment in accordance with the present invention;

FIG. 2 is a cut-away side view of an embodiment in accordance with the present invention; and

FIG. 3 is a top-down cut-away view of an embodiment in accordance with the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

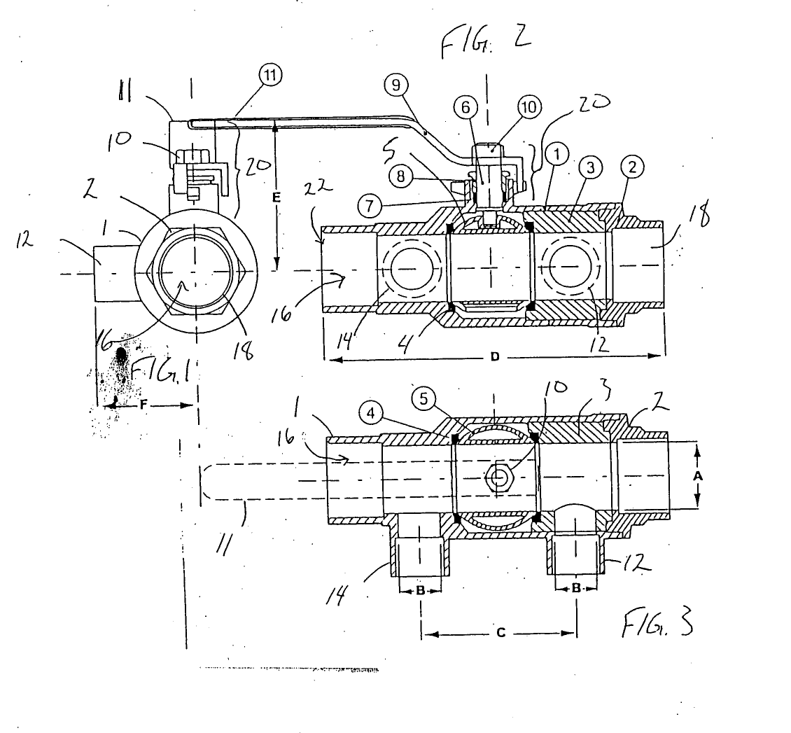

Turning to FIG. 1, an axial view of an embodiment in accordance with the present invention is shown. A valve body 1 defines a flow channel 16 that extends axially through the valve body 1 from a first primary loop port 18 to a second primary loop port. The valve body 1 also defines a first secondary loop port 12 and a second secondary loop port (not shown). An end cap 2 is affixed to the valve body 1 at the first primary loop port 18. An actuator 20 extends from the valve body 1 enabling a first and second position of the valve. The actuator 20 includes a handle 11 affixed to the valve body by a handle nut 10. A flow diversion device (not shown here) is connected to the handle 11. The position of the actuator 20 in a first position configures the flow diversion device to allow flow axially through the entire flow channel 16 from the first primary loop port to the second primary loop flow port as well as through the first and second secondary loop flow ports. In a second position of the actuator 20, the flow diversion device blocks the flow from the first primary loop port 18 to the second primary loop port. In this position, the first primary loop port 18 is in fluid communication with the first secondary loop port 12 only and the second primary loop port is in fluid communication with the second secondary loop port only. In a hydronic piping system, the valve in this position will break the primary loop and force all flow into the secondary loop. This position is used in such systems to purge the secondary loop of air during installation or maintenance.

Turning now to FIG. 2 and FIG. 3, cut-away views of an embodiment of the present invention are shown. FIG. 2 depicts the embodiment from a side-view, while FIG. 3 depicts the embodiment from a top-view. A valve body 1 defines a flow channel 16 axially though the valve from the first primary loop port 18 to the second primary loop port 22. The first secondary loop port 12 and the second secondary loop port 14 are also in fluid communication with the flow channel 16. The end cap 2 is disposed into the valve body 1 and mated with a seat retainer 3. The actuator 20 extends from the valve body 1 containing a stem 6, a stem seal 7 and a packing gland 8. The actuator 20 also includes a handle 11 that is affixed to the stem 6 with the handle nut 10. The actuator 20 repositions the flow diversion device 5 to alter the flow channels of the valve. The flow diversion device 5 is disposed within the valve body 1 in between the first secondary loop port 12 and the second secondary loop port 14. The flow diversion device in this embodiment includes a ball defining two openings equal in diameter to the diameter of the flow channel 16. The flow diversion device 5 is disposed between valve seats 4. The position of the actuator 20 in a first position positions the flow diversion device to allow flow axially through the entire flow channel 16 from the first primary loop port to the second primary flow port as well as through the first and second secondary flow ports. In a second position of the actuator 20, the flow diversion device blocks the flow from the first primary port 18 to the second primary port. In this position, the first primary loop port 18 is in fluid communication with the first secondary loop port 12 only and the second primary loop port is in fluid communication with the second secondary loop port only.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A purge valve comprising:
a valve body having a first primary loop port and a second primary loop port, the valve body defining a first secondary loop port and second secondary loop port, the valve body defining a flow channel and a valve portion, the valve portion in communication with the first, second, third, and forth port; and
a flow diversion device disposed within the valve portion, the flow diversion device configurable between a first and second position such that when the flow diversion device is in the first position the first primary loop port is in communication with the second primary loop port, the first secondary loop port and the second secondary loop port and when the flow diversion device is in a second position the first primary loop port is in communication with the first secondary loop port only and the second primary loop port is in communication with the second secondary loop port only.

2. The purge valve of claim 1, wherein the flow diversion device is a ball valve.

3. The purge valve of claim 1 further comprising a handle, the handle actuating the flow diversion device between the first position and the second position.

4. The purge valve of claim 1 wherein the valve body is made of brass.
